(19) United States
(12) Patent Application Publication
(10) Pub. No.: US 2026/0001458 A1
(43) Pub. Date: Jan. 1, 2026

(54) VEHICLE SEAT

(71) Applicant: TACHI-S CO., LTD., Tokyo (JP)

(72) Inventors: Youhei Shinada, Tokyo (JP); Mamoru Morita, Tokyo (JP); Takuya Haraguchi, Tokyo (JP); Cong Tien Nguyen, Tokyo (JP)

(73) Assignee: TACHI-S CO., LTD., Tokyo (JP)

(21) Appl. No.: 19/246,827

(22) Filed: Jun. 24, 2025

(30) Foreign Application Priority Data
Jun. 27, 2024 (JP) 2024-104389

(51) Int. Cl. B60N 2/58

(52) U.S. Cl. CPC B60N 2/5825

(57) ABSTRACT

A vehicle seat capable of improving the workability of installation work of a side finisher is provided. Displacement of the side finisher in an up-down direction is restricted when a guide projection slides in a guide groove, and displacement in a left-right direction is also restricted when it has slid to the rear end of the guide groove. Accordingly, the relative positions between the fitting holes and the fitting projections can be easily determined by sliding the guide projection to the rear end of the guide groove. Since the guide projection is formed on the rear side of the fitting projections, the side finisher can be easily bent outward in the left-right direction in a region in which the fitting projections are formed. Since the fitting projections can be easily fitted into the fitting holes, the workability of installation work of the side finisher can be improved.

### BACKGROUND OF THE INVENTION

### 1. Field of the Invention

The present invention relates to a vehicle seat and, more particularly, to a vehicle seat capable of improving the workability of installation work of a side finisher.

### 2. Description of the Related Art

For example, Japanese Unexamined Patent Application Publication No. 2013-001149 (for example, paragraphs 0014 to 0020 and FIG. 1) describes a technique for covering the side surface of a side frame 31 of a vehicle seat with a side shield member 50. The vehicle seat includes an up-and-down lever 28 for raising and lowering the side frame 31, and the side shield member 50 has a slit portion 54 into which the up-and-down lever 28 is inserted.

In addition, the side frame 31 and the side shield member 50 include boss portions 37a and 37b and clips 75 and 76 that can engage with each other. When the side shield member 50 is attached to the side frame 31, the clips 75 and 76 are engaged with the boss portions 37a and 37b from the lateral side with the up-and-down lever 28 inserted into the slit portion 54.

### SUMMARY OF THE INVENTION

However, since the displacement (movement) of the side shield member 50 in the left-right direction is restricted by the up-and-down lever 28 with the up-and-down lever 28 inserted into the slit portion 54, it takes effort to adjust the relative positions between the boss portions 37a and 37b and the clips 75 and 76. Accordingly, there is a problem with the workability of installation work of the side shield member 50 (side finisher).

The present invention addresses the problem described above with an object of providing a vehicle seat that can improve the workability of installation work of the side finisher.

To achieve this object, according to the present invention, there is provided a vehicle seat including: a side frame, provided in a cushion frame, that extends in a front-rear direction; an operating lever, provided on a lateral side of the side frame, that is operated by an occupant; and a side finisher that has an insertion hole into which the operating lever is inserted and that covers a side surface of the side frame, in which the side finisher includes a guide projection and a fitting projection, formed on a front side of the insertion hole, that project to a side closer to the side frame, the side closer to the side frame has a guide groove that extends in the front-rear direction and into which the guide projection is slidably inserted through an opening portion on a front end side, and a fitting hole into which the fitting projection is fitted from the lateral side, the guide projection restricts displacement of the side finisher in an up-down direction and in a left-right direction at least at a terminal position of sliding toward a rear end side of the guide groove, and the guide projection is formed on a rear side of the fitting projection.

In a vehicle seat according to a first aspect, the side finisher includes the guide projection and the fitting projection, formed on the front side of the insertion hole of the operating lever, that project to the side closer to the side frame. Since the side closer to the side frame has the guide groove that extends in the front-rear direction and into which the guide projection can be slidably inserted through the opening portion on a front end side and a fitting hole into which the fitting projection is fitted from the lateral side are formed, by the guide projection being slid along the guide groove to the rear side, the movement of the side finisher toward a position at which the fitting projection can be fitted into the fitting hole can be guided.

Since the guide projection restricts displacement of the side finisher in an up-down direction and in a left-right direction at least at a terminal position of sliding toward the rear end side of the guide groove, the relative position between the fitting hole and the fitting projection can be easily determined by the guide projection being slid to the terminal position of on the rear end side of the guide groove.

On the other hand, when such a guide projection is provided on the side finisher, for example, in a structure in which the guide projection is disposed on the front side of the fitting projection, the bending of the side finisher toward the outside in the left-right direction is restricted by the operating lever located on the rear side of the fitting projection and the guide projection located on the front side. Accordingly, the work of fitting the fitting projection into the fitting hole requires effort.

On the other hand, in the vehicle seat according to the first aspect, since the guide projection is formed on the rear side of the fitting projection, the side finisher can be easily bent toward the outside in the left-right direction in a region in which the fitting projection is formed. Accordingly, since the work of fitting the fitting projection into the fitting hole can be easily performed, the effect of improving the workability of installation work of the side finisher is obtained.

In a vehicle seat according to a second aspect, in addition to the effect obtained by the vehicle seat according to the first aspect, components on the side closer to the side frame can be suppressed from interfering with the side finisher when the operating lever is inserted into the insertion hole of the side finisher since the operating lever is inclined to the outside in the left-right direction as approaching to the front end side. Accordingly, the effect of improving the workability of installation work of the side finisher is obtained.

In a vehicle seat according to a third aspect, in addition to the effect obtained by the vehicle seat according to the first aspect, the following effect is also obtained. On the side closer to the side frame, a guide surface that extends in the front-rear direction while facing the side finisher on the front side of the guide groove is formed. Since displacement of the guide projection toward the inside in the left-right direction can be restricted by the guide surface when the guide projection slides toward the rear end side of the guide groove, sliding of the guide projection toward the guide groove can be guided by the guide surface. Accordingly, since the guide projection can be easily inserted for the rear end side of the guide groove, the effect of improving the workability of installation work of the side finisher is obtained.

In a vehicle seat according to a fourth aspect, in addition to the effect obtained by the vehicle seat according to the first aspect, the following effect is also obtained. On the side closer to the side frame, a first surface in which the fitting hole is formed and a second surface, continuous with the front edge of the first surface, that is inclined to the inside in the left-right direction as moving away from the first surface to the front side are formed. As a result, when the guide projection slides toward the rear end side of the guide groove, the fitting projection slides along the second surface (the fitting projection runs on the second surface), and accordingly, the movement of the fitting projection toward the fitting hole can be guided. Accordingly, the effect of improving the workability of installation work of the side finisher is obtained.

In a vehicle seat according to a fifth aspect, in addition to the effect obtained by the vehicle seat according to the first aspect, the following effect is also obtained. An insertion groove that vertically passes through the guide projection and into which the rear end portion of the guide groove is inserted is formed in the rear surface of the guide projection. Since an inclined surface inclined to expand the groove width in the left-right direction of the insertion groove toward the rear side is formed at the rear end of the insertion groove, insertion of the rear end portion of the guide groove into the insertion groove can be guided by the inclined surface. Accordingly, since the rear end portion of the guide groove can be easily inserted into the insertion groove, the effect of improving the workability of installation work of the side finisher is obtained.

In a vehicle seat according to a sixth aspect, in addition to the effect obtained by the vehicle seat according to the first aspect, the following effect is also obtained. The side finisher has a low-stiffness region in which stiffness against bending in the left-right direction is lower than that of a region in which the fitting projection is formed. Since the low-stiffness region is formed between the guide projection and the fitting projection, when the fitting projection is fitted into the fitting hole, the side finisher is likely to be bent toward the outside in the left-right direction, starting from the low-stiffness region. Accordingly, since the fitting projection can be easily fitted into the fitting hole, the effect of improving the workability of installation work of the side finisher is obtained.

In a vehicle seat according to a seventh aspect, in addition to the effect obtained by the vehicle seat according to the first aspect, the following effect is also obtained. Since the mounting bracket that is attached to the side surface of the side frame and in which the guide groove and the fitting hole are formed is provided, a common side frame can be applied to different vehicle seats by the shape of the mounting bracket being changed according to the types (the shapes and the positions of the guide projections and the fitting projections of the side finisher) of the vehicle seats. As a result, since a mold of the mounting bracket that is smaller than the side frame only needs to be created without a new mold of the side frame being created, the effect of reducing the manufacturing cost of a vehicle seat is obtained.

In a vehicle seat according to an eighth aspect, in addition to the effect obtained by the vehicle seat according to the first aspect, the following effect is also obtained. The fitting projection includes an insertion portion inserted into the fitting hole and a claw portion that projects in the direction orthogonal to the left-right direction from the insertion portion and is engaged with the inside in the left-right direction of the fitting hole. In the direction in which the claw portion projects, the displacement of the side finisher is restricted by the engagement between the fitting hole and the insertion portion, and a gap is formed between the fitting hole and the insertion portion in the direction orthogonal to the left-right direction and the direction in which the claw portion projects.

The fitting projection includes at least a first fitting projection that includes a claw portion that projects in a first direction (for example, the front-rear direction) and is fitted into the first fitting hole and a second fitting projection that includes the claw portion that projects in a second direction (for example, the up-down direction) that differs from the first direction and is fitted into the second fitting hole. As a result, the engagement between the first and second fitting holes and the insertion portions of the first and second fitting projections can restrict the displacement of the side finisher in both the first direction and the second direction (for example, in two directions including the front-rear direction and the up-down direction). Accordingly, the play of the side finisher can be effectively suppressed.

In addition, in individual directions that are orthogonal to the projecting directions (the first direction and the second direction) of the claw portions of the first and second fitting projections and the left-right direction, since gaps are formed between the first and second fitting holes and the insertion portions of the first and second fitting projections, the disposition error of the first and second fitting projections (insertion portions) can be absorbed by the amount corresponding to the gaps. As a result, even when error occurs in the relative position between the first and second fitting projections due to the dimensional error of the side finisher or the like, the effect of fitting the first and second fitting projections into the first and second fitting holes is obtained.

In a vehicle seat according to a ninth aspect, in addition to the effect obtained by the vehicle seat according to the eighth aspect, the following effect is also obtained. Since the first fitting projection is formed on the front end side of the side finisher, a load directed diagonally backward from the occupant is likely to act on the fitting portion between the first fitting hole and the first fitting projection. Accordingly, for example, when a gap in the front-rear direction is formed between the first fitting hole and the insertion portion of the first fitting projection, the first fitting projection is likely to be disengaged from the first fitting hole.

In addition, since the second fitting projection is formed at the upper rear of the first fitting projection, a load directed diagonally downward from the occupant is likely to act on the fitting portion between the second fitting hole and the second fitting projection. Accordingly, for example, when a gap in the up-down direction is formed between the second fitting hole and the insertion portion of the second fitting projection, the second fitting projection is likely to be disengaged from the second fitting hole.

On the other hand, in the vehicle seat according to the ninth aspect, a gap in the up-down direction is formed between the first fitting hole and the first fitting projection, and a gap in the front-rear direction is formed between the second fitting hole and the second fitting projection. As a result, even when a load as described above is applied by the occupant to the fitting portions between the first and second fitting holes and the first and second fitting projections, the effect of making the first and second fitting projections less likely to be disengaged from the first and second fitting holes is obtained.

### BRIEF DESCRIPTION OF THE DRAWINGS

FIG. 1 is a perspective view of a vehicle seat.

FIG. 2 is a perspective view of a side finisher.

FIG. 3 is a partially enlarged side view of the vehicle seat as viewed in the direction of arrow III in FIG. 1.

FIG. 4A is a partially enlarged cross-sectional view illustrating a cross section taken along line IV-IV in FIG. 3 of the vehicle seat in which an operating lever has been inserted into an insertion hole of the side finisher.

FIG. 4B is a partially enlarged cross-sectional view of the vehicle seat in which a guide projection has started to be inserted into a guide groove from the state illustrated in FIG. 4A.

FIG. 5A is a partially enlarged cross-sectional view of the vehicle seat in which a hanging portion of a mounting bracket has been inserted into an insertion groove of the side finisher from the state illustrated in FIG. 4B.

FIG. 5B is a partially enlarged cross-sectional view of the vehicle seat in which the hanging portion has been inserted into the insertion groove from the state illustrated in FIG. 5A.

FIG. 6 is a partially enlarged cross-sectional view illustrating line IV-IV in FIG. 3 of the vehicle seat in which the side finisher has been attached to the mounting bracket.

### DESCRIPTION OF THE PREFERRED EMBODIMENTS

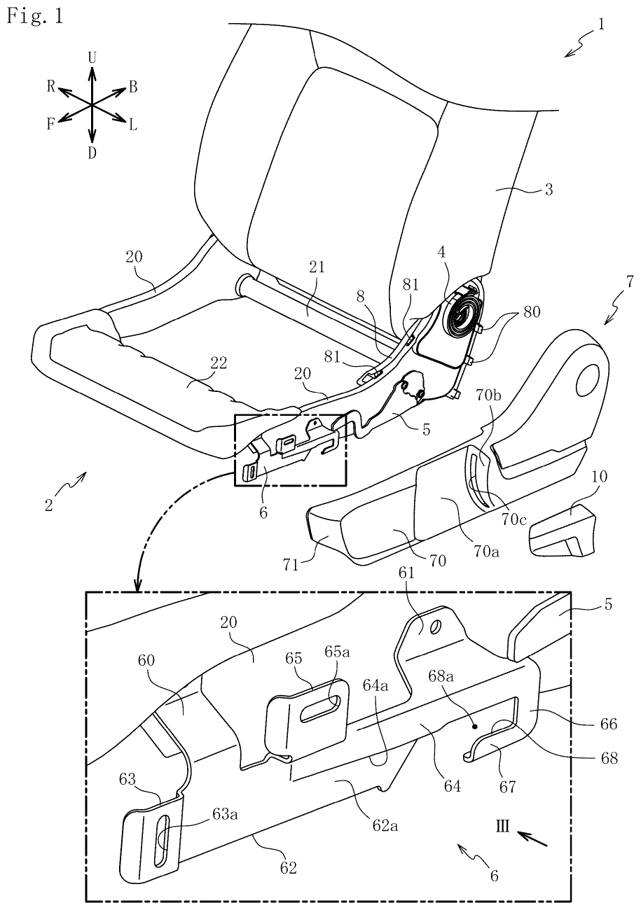

Preferred embodiments of the present invention will be described below with reference to the accompanying drawings. First, an overall structure of a vehicle seat 1 will be described with reference to FIG. 1. FIG. 1 is a perspective view of the vehicle seat 1. It should be noted that FIG. 1 illustrates a state in which a seat pad (cushion pad) supported by a cushion frame 2 and a covering skin that covers the seat pad have been removed. In addition, arrows U and D, arrows L and R, and arrows F and B in FIG. 1 indicate an up-down direction, a left-right direction, and a front-rear direction of the vehicle seat 1, respectively (the same applies to subsequent drawings).

As illustrated in FIG. 1, the vehicle seat 1 is a seat installed in a vehicle, such as an automobile, and includes a cushion frame 2 that forms the skeleton of a seat surface (seat cushion). A seat back 3 (back frame) is coupled to the rear end (the end portion on arrow B side) of the cushion frame 2 in a tiltable manner via a reclining device 4.

The cushion frame 2 includes a pair of side frames 20 that extend in front-rear direction (direction indicated by arrows F and B), and the side frames 20 are provided with a space therebetween in the left-right direction (direction indicated by arrows L and R). Portions at the rear end side of the pair of side frames 20 are coupled to each other by a rear frame 21 that extends left and right, and portions at the front end side thereof are coupled to each other by a front frame 22 (front panel) that extends left and right.

In the following description, the side surface of the side frame 20 that faces the outside (arrow L side) in the left-right direction is referred to as the outer surface, and the side surface that faces the side (arrow R side) opposite to the outside is referred to as the inner surface (this also applies to other components of the vehicle seat 1). An operating lever 5 is attached to the outer surface of the side frame 20 rotatably about an axis along the left-right direction. The operating lever 5 according to the present embodiment is operated by the occupant to release the lock of the reclining device 4, but the operating lever 5 may also raise and lower the cushion frame 2.

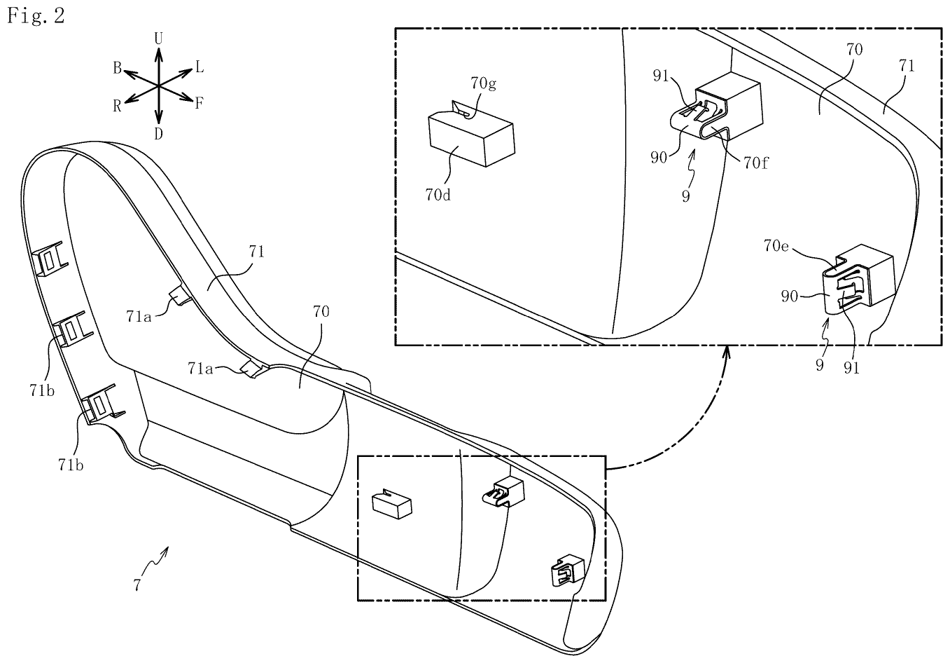

The mounting bracket 6 is fixed to a portion of the outer surface of the side frame 20 that is located on the front side of the operating lever 5. The mounting bracket 6 is a component to which the side finisher 7 that covers the side surface of the side frame 20 is attached. First, the detailed structure of the side finisher 7 will be described with reference to FIGS. 1 and 2. FIG. 2 is a perspective view of the side finisher 7.

As illustrated in FIGS. 1 and 2, the side finisher 7 includes a covering portion 70 that extends in the front-rear direction (direction indicated by arrows F and B) and covers the outer surface of the side frame 20 and an outer peripheral portion 71 that rises from the outer edge of the covering portion 70 toward the side frame 20, and these components 70 and 71 are integrally formed of a resin material.

A recessed portion 70a (see FIG. 1) is provided in the central portion in the front-rear direction of the outer surface of the covering portion 70. Since this recessed portion 70a is formed, a step surface 70b facing the front side is created on the outer surface of the covering portion 70, and accordingly, an insertion hole 70c extending vertically is formed in the step surface 70b (see FIG. 1). The insertion hole 70c that passes through this step surface 70b is a portion into which the operating lever 5 is inserted.

The outer peripheral portion 71 of the side finisher 7 is formed in a wall shape that surrounds substantially the entire outer edge of the covering portion 70. A portion of the covering portion 70 on the rear end side (the rear side of the insertion hole 70c) is inclined upward toward the upper rear side, and claws 71a and engagement holes 71b (see FIG. 2) are formed integrally with a portion of the outer peripheral portion 71 that convers this inclined portion.

The plurality of claws 71a and the plurality of engagement holes 71b are arranged along the inner peripheral surface of the outer peripheral portion 71, but, in FIG. 2, some of the claws 71a and engagement holes 71b are not illustrated to simplify the drawing. These claws 71a and engagement holes 71b are used to fix the rear end portion of the side finisher 7 to an inner cover 8 (see FIG. 1) that covers the inner surface of the side frame 20.

The inner cover 8 is a resin component that covers an inner surface of the side frame 20 on the rear end side (reclining device 4), and claws 80 and engagement holes 81 are formed integrally with the inner cover 8 at positions that correspond to the claws 71a and the engagement holes 71b of the side finisher 7. By the claws 71a and the engagement holes 71b of the side finisher 7 being engaged with the engagement holes 81 and the claws 80 of the inner cover 8, respectively, the rear end portion of the side finisher 7 is fixed to the side frame 20 (inner cover 8).

On the other hand, a portion of the side finisher 7 on the front end side (on the front side of the insertion hole 70c) is fixed to the side frame 20 (mounting bracket 6 illustrated in FIG. 1) by a guide projection 70d and fitting projections 70e and 70f (see the enlarged portion in FIG. 2).

The guide projection 70d is slidably engaged with a guide groove 68 (see the enlarged portion in FIG. 1), which will be described later, of the mounting bracket 6, and the fitting projections 70e and 70f are fitted into fitting holes 63a and 65a (see the enlarged portion in FIG. 1) of the mounting bracket 6. These projections 70d to 70f are formed integrally with the inner surface of the covering portion 70.

An insertion groove 70g that passes through the guide projection 70d vertically is formed in the rear surface of the guide projection 70d. This insertion groove 70g is a groove into which a hanging portion 66 (see the enlarged portion in FIG. 1) of the mounting bracket 6, which will described later, is inserted.

Clips 9 (see the enlarged portion in FIG. 2) is attached to the tips of the fitting projections 70e and 70f. The clips 9 mainly include U-shaped insertion portions 90 that are mounted on the fitting projections 70e and 70f, and an elastically deformable claw portions 91 that project from the side surfaces of the insertion portions 90. Since a known structure can be adopted, a detailed description is omitted. In addition, the shapes of the fitting projections 70e and 70f are illustrated schematically to simplify the drawings in FIG. 2, but these fitting projections 70e and 70f may also adopt a known structure.

It should be noted that a clip 6 in Japanese Unexamined Patent Application Publication No. 2017-196937 is exemplified as a known structure of the clip 9, and a clip pushing portion 411 in this patent document is exemplified as a known structure of the fitting projections 70e and 70f.

Although described in detail later, when the side finisher 7 is attached to the side frame 20, the operating lever 5 is inserted into the insertion hole 70c, and then the clips 9 of the fitting projections 70e and 70f are fitted into the fitting holes 63a and 65a of the mounting bracket 6. Next, the installation of the side finisher 7 is completed by a cover 10 (see FIG. 1) being attached to the tip of the operating lever 5.

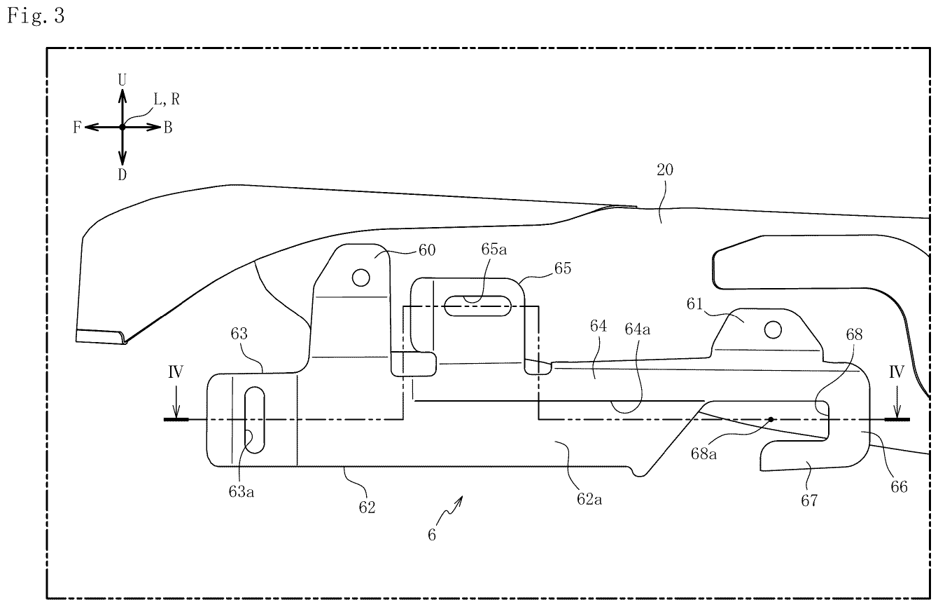

Next, the detailed structure of the mounting bracket 6 will be described with reference to FIGS. 1 and 3. FIG. 3 is a partially enlarged side view of the vehicle seat 1 as seen in the direction of arrow III in FIG. 1.

As illustrated in FIGS. 1 and 3, the mounting bracket 6 includes a first mounting portion 60 and a second mounting portion 61 spaced apart in the front-rear direction (direction indicated by arrows F and B). These mounting portions 60 and 61 are fixed to the outer surface of the side frame 20 with bolts, which are not illustrated. The mounting portions 60 and 61 are inclined downward toward the outside in the left-right direction (arrow L side) from the side frame 20, and a lateral guide portion 62 is formed below the first mounting portion 60 located on the front end side in the mounting bracket 6. The outer surface of the lateral guide portion 62 is formed as a lateral guide surface 62a that guides the sliding of the inner surface of the guide projection 70d (see FIG. 2).

A fitting portion 63 that projects to the outside in the left-right direction from the lateral guide surface 62a is formed on the front side of the lateral guide portion 62 (lateral guide surface 62a), and a fitting hole 63a that passes through in the left-right direction (direction indicated by arrows L and R) is formed in the fitting portion 63. The fitting hole 63a is a long hole that extends vertically (direction indicated by arrows U and D), and the clip 9 (see FIG. 2) of the fitting projection 70e is fitted into the fitting hole 63a.

An upper guide portion 64 that extends in the front-rear direction is formed above the lateral guide surface 62a of the lateral guide portion 62. The upper guide portion 64 is formed to project to the outside in the left-right direction from the lateral guide surface 62a, and the lower surface of the upper guide portion 64 is formed as an upper guide surface 64a that guides the sliding of the upper surface of the guide projection 70d (see FIG. 2).

A fitting portion 65 that projects to the outside in the left-right direction ahead of the upper guide portion 64 is formed above the front end side of the upper guide portion 64, and a fitting hole 65a that passes through the fitting portion 65 in the left-right direction is formed. The fitting hole 65a is a long hole that extends in the front-rear direction (direction indicated by arrows F and B), and the clip 9 (see FIG. 2) of a fitting projection 70f described above is fitted into the fitting hole 65a of the fitting portion 65.

The upper guide portion 64 extends closer to the rear side than does the lateral guide surface 62a, and the lower end portion of the second mounting portion 61 is connected to the portion of this upper guide portion 64 on the rear end side. The hanging portion 66 hangs downward from the rear end of the upper guide portion 64, and a lower guide portion 67 is bent toward the front side from the lower end of the hanging portion 66.

These portions 60 to 67 that constitute the mounting bracket 6 are formed integrally with each other by a metal plate being bent (pressed). That is, each of the individual portions 60 to 67 of the mounting bracket 6 is formed in a flat plate shape.

The guide groove 68 surrounded by the portion of the upper guide portion 64 on the rear end side, the hanging portion 66, and the lower guide portion 67 is formed in the mounting bracket 6, and the guide groove 68 is a long hole (hole extending in the front-rear direction) that has an opening 68a on the front side. When the side finisher 7 is attached to the mounting bracket 6, the guide projection 70d (see FIG. 2) is inserted through the opening 68a of the guide groove 68.

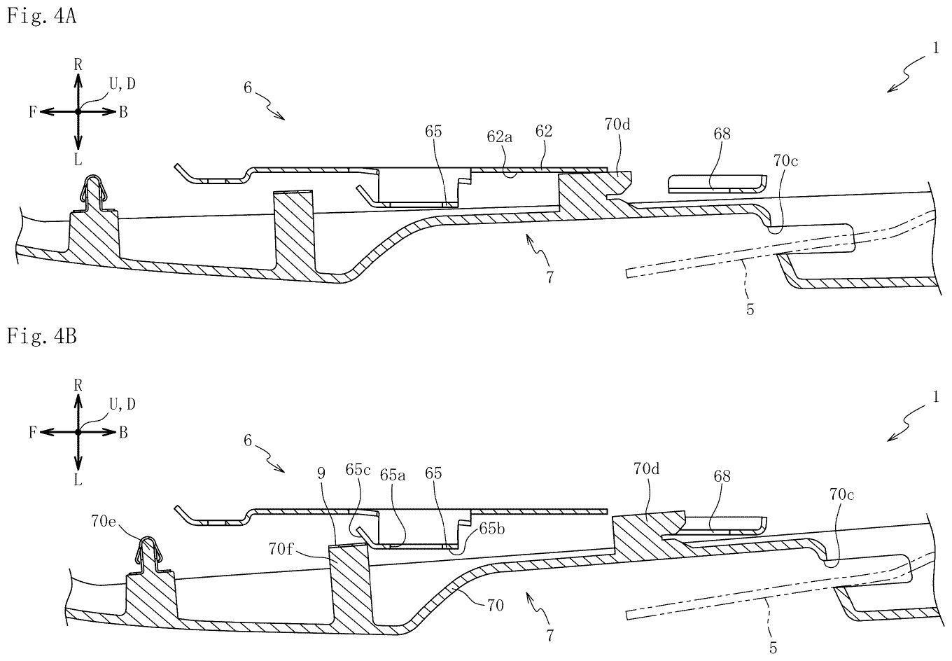

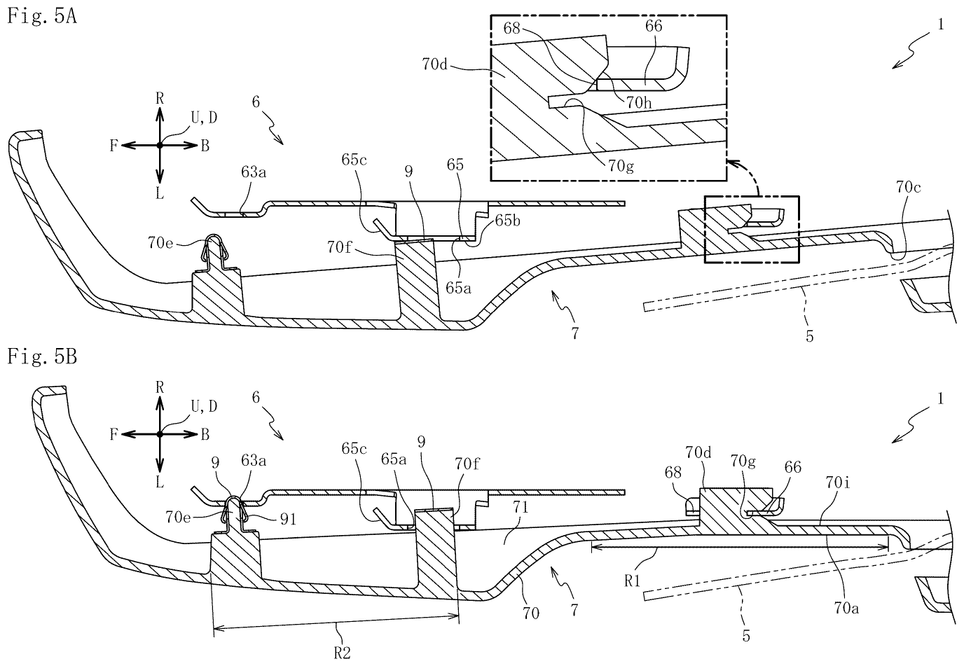

Next, the method of mounting the side finisher 7 will be described with reference to FIGS. 4 and 5. FIG. 4A is a partially enlarged cross-sectional view illustrating a cross section taken along line IV-IV in FIG. 3 of the vehicle seat 1 in which an operating lever 5 has been inserted into the insertion hole 70c of the side finisher 7, and FIG. 4B is a partially enlarged cross-sectional view of the vehicle seat 1 in which the guide projection 70d has started to be inserted into the guide groove 68 from the state illustrated in FIG. 4A.

In addition, FIG. 5A is a partially enlarged cross-sectional view of the vehicle seat 1 in which the hanging portion 66 of the mounting bracket 6 has been inserted into the insertion groove 70g of the side finisher 7 from the state illustrated in FIG. 4B, and FIG. 5B is a partially enlarged cross-sectional view of the vehicle seat 1 in which the hanging portion 66 has been inserted into the insertion groove 70g from the state illustrated in FIG. 5A. It should be noted that, in FIGS. 4 and 5, the outline of the operating lever 5 is illustrated by a dot-dot-dash line.

As illustrated in FIG. 4A, when the side finisher 7 is attached to the mounting bracket 6, first, the operating lever 5 is inserted from the rear side (arrow B side) of the insertion hole 70c. Since the operating lever 5 is inclined to the outside in the left-right direction (the direction between arrow F and arrow L) toward the front end (tip) thereof, it is possible to suppress the fitting portion 65 or the like (the component closer to the side frame 20) of the mounting bracket 6 from interfering with the guide projection 70d of the side finisher 7 when the operating lever 5 is inserted into the insertion hole 70c.

After the operating lever 5 is inserted into the insertion hole 70c, the guide projection 70d is slid to the rear side toward the guide groove 68. The sliding of the guide projection 70d is guided by the lateral guide surface 62a of the lateral guide portion 62.

Since the lateral guide surface 62a is a flat plane that extends in the front-rear direction and faces the side finisher 7 on the front side of the guide groove 68, the lateral guide surface 62a can guide the sliding of the guide projection 70d toward the guide groove 68 by the guide projection 70d being slid toward the rear side along the lateral guide surface 62a. Accordingly, the guide projection 70d can be easily inserted into the guide groove 68.

In addition, since the side finisher 7 can be prevented from being excessively pushed to the inside in the left-right direction (arrow R side) by the contact between the guide projection 70d and the lateral guide surface 62a, the side finisher 7 can be suppressed from excessively deformed. Accordingly, the side finisher 7 can be suppressed from being broken.

In addition, although not illustrated, when the guide projection 70d slides along the lateral guide surface 62a, this sliding is also guided by the upper guide surface 64a of the upper guide portion 64 (see FIG. 3). The upper guide surface 64a is a surface (surface facing downward) orthogonal to the lateral guide surface 62a, and the upper guide surface 64a that extends linearly in the front-rear direction is continuous with the upper edge of the guide groove 68. Accordingly, the guide projection 70d can be easily inserted into the guide groove 68 by the guide projection 70d being slid to the rear side while the guide projection 70d is pushed against (engaged with) the lateral guide surface 62a and the upper guide surface 64a.

As illustrated in FIG. 4B, after the guide projection 70d has started to be inserted into the guide groove 68, the sliding of the clip 9 of the fitting projection 70f toward the outer surface 65b of the fitting portion 65 (the surface in which the fitting hole 65a is formed) is guided by the inclined surface 65c. The inclined surface 65c is formed by the front end portion of the fitting portion 65 (the end portion on the arrow F side) being bent toward the inside in the left-right direction (arrow R side), and the connection portion between the outer surface 65b and the inclined surface 65c of the fitting portion 65 is a curved surface that is smoothly curved.

The inclined surface 65c is a flat plane that is inclined toward the inside in the left-right direction (the direction between arrow F and arrow R) as moving away from the outer surface 65b of the fitting portion 65 toward the front side. Accordingly, when the guide projection 70d is slid toward the rear end side of the guide groove 68, the clip 9 of the fitting projection 70f slides so as to run on the inclined surface 65c. The sliding of the fitting projection 70f along the inclined surface 65c can guide the movement of the fitting projection 70f toward the fitting hole 65a while the side finisher 7 is bent toward the outside in the left-right direction.

As illustrated in FIG. 5A, in a state in which the clip 9 of the fitting projection 70f completely run on the outer surface 65b of the fitting portion 65, a portion of the side finisher 7 on the rear end side is inclined to the inside in the left-right direction. This is because the displacement (movement) of the side finisher 7 toward the outside in the left-right direction is restricted by the engagement between the insertion hole 70c and the operating lever 5.

Accordingly, when the hanging portion 66 (see the enlarged portion in FIG. 5A) of the mounting bracket 6 is inserted into the insertion groove 70g of the guide projection 70d, the insertion groove 70g is inclined with respect to the hanging portion 66. The insertion of the hanging portion 66 into the inclined insertion groove 70g is guided by the inclined surface 70h that is continuous with the rear end of the insertion groove 70g.

The inclined surface 70h is a flat plane that is inclined to the inside in the left-right direction as moving away from the insertion groove 70g to the rear side. That is, since the inclined surface 70h is inclined so as to increase the groove width in the left-right direction of the insertion groove 70g toward the rear side, by the inclined surface 70h as described above being formed, even when the hanging portion 66 is inserted into the insertion groove 70g with the side finisher 7 inclined with respect to the mounting bracket 6, the insertion of the hanging portion 66 can be guided by the inclined surface 70h. Accordingly, the hanging portion 66 (the rear end portion of the guide groove 68) can be easily inserted into the insertion groove 70g.

The width of the insertion groove 70g is substantially the same as the thickness of the plate-like hanging portion 66, and when the hanging portion 66 starts to be inserted into the insertion groove 70g to some extent, the displacement of the side finisher 7 in the left-right direction is restricted by the engagement between the insertion groove 70g and the hanging portion 66. Accordingly, in a state in which the hanging portion 66 is inserted into the insertion groove 70g and the clip 9 of the fitting projection 70f runs on the outer surface 65b of the fitting portion 65 (state before the fitting projections 70e and 70f are fitted into the fitting holes 63a and 65a), a portion of the side finisher 7 on the front end side is bent toward the outside in the left-right direction at the maximum.

In addition, as illustrated in FIG. 5B, at the terminal position of the guide projection 70d in the guide groove 68, the hanging portion 66 is inserted into the insertion groove 70g until the hanging portion 66 makes contact with the front end (the bottom surface of the groove) of the insertion groove 70g. In the state in which the guide projection 70d slides to the terminal position, the clips 9 of the fitting projections 70e and 70f are shallowly fitted into the fitting holes 63a and 65a.

In the state in which the clips 9 are shallowly fitted into the fitting holes 63a and 65a, the claw portions 91 of the clips 9 are engaged with the edges of the fitting holes 63a and 65a. Even in this state, a portion of the side finisher 7 on the front end side is bent toward the outside in the left-right direction. In addition, similar bending may occur in the side finisher 7 when the clips 9 of the fitting projections 70f run on the inclined surface 65c described above, but, in the present embodiment, such bending of the side finisher 7 can be easily occur.

Specifically, the recessed portion 70a is formed on the outer surface of the covering portion 70 of the side finisher 7 as illustrated in FIG. 5B, and accordingly, a raised portion 70i corresponding to the recessed portion 70a is formed on the inner surface of the covering portion 70. In the region in which the raised portion 70i is formed, the height of the outer peripheral portion 71 that rises from the outer edge of the covering portion 70 is lower than the other regions. Accordingly, the region in which the raised portion 70i is formed is a low-stiffness region R1 in which the stiffness of the side finisher 7 is relatively low, and the guide projection 70d is formed in this low-stiffness region R1 (the inner surface of the raised portion 70i).

On the other hand, the fitting projections 70e and 70f are formed on the front side of the low-stiffness region R1 (raised portion 70i). In the region R2 (the region extending from the front end of the fitting projection 70e to the rear end of the fitting projection 70f) in which the fitting projections 70e and 70f are formed, the height of the outer peripheral portion 71 is greater and the stiffness of the side finisher 7 is greater than in the low-stiffness region R1.

That is, in the present embodiment, a portion of the low-stiffness region R1 having low stiffness against bending in the left-right direction is formed between the guide projection 70d and the fitting projections 70e and 70f. As a result, when the clip 9 of the fitting projection 70f runs on the inclined surface 65c or the hanging portion 66 is inserted into the insertion groove 70g, the side finisher 7 is likely to be bent toward the outside in the left-right direction, starting from the low-stiffness region R1. Accordingly, since the fitting projections 70e and 70f can be smoothly slid toward the fitting holes 63a and 65a, the fitting projections 70e and 70f can be easily fitted into the fitting holes 63a and 65a.

In addition, by the low-stiffness region R1 as described above being formed, the side finisher 7 can be suppressed from being plastically deformed due to bending toward the outside in the left-right direction. Accordingly, the side finisher 7 can be suppressed from being broken during installation.

In addition, the fitting holes 63a and 65a and the guide groove 68 can be formed in the side frame 20 (see FIG. 1 and the like), but, in the present embodiment, the fitting holes 63a and 65a and the guide groove 68 are formed in the mounting bracket 6 attached to the side surface of the side frame 20. As a result, by the shape of the mounting bracket 6 being changed in accordance with the types (the shapes and the positions of the projections 70d to 70f of the side finisher 7) of the vehicle seat 1, a common side frame 20 can be applied to different vehicle seats. As a result, the mold of the mounting bracket 6, which is smaller than the side frame 20, only needs to be created, the need to create a new mold of the side frame 20 can be eliminated. Accordingly, the manufacturing cost of the vehicle seat 1 can be reduced.

Although not illustrated, the dimensions of the guide projection 70d in the up-down direction (direction indicated by arrows U and D) are formed to be identical to or slightly smaller than the groove width in the up-down direction of the guide groove 68. Accordingly, when the guide projection 70d slides along the guide groove 68, the displacement (the inclination in the up-down direction) of the side finisher 7 in the up-down direction is restricted by the engagement between the guide groove 68 and the guide projection 70d.

Accordingly, by the guide projection 70d being slid along the guide groove 68, the fitting projections 70e and 70f can be slid toward the rear side (toward the fitting holes 63a and 65a) with the relative heights of the fitting holes 63a and 65a and the fitting projections 70e and 70f in the up-down direction matched. That is, only by sliding the guide projection 70d toward the rear side along the guide groove 68, the fitting projections 70e and 70f can be slid toward a position at which the fitting projections 70e and 70f can be fitted into the fitting holes 63a and 65a.

In addition, since the hanging portion 66 is inserted into the insertion groove 70g when the guide projection 70d slides to the terminal position of the guide groove 68 as described above, the engagement between the insertion groove 70g and the hanging portion 66 can position the side finisher 7 in the left-right direction (restrict the displacement of the side finisher 7 in the left-right direction).

In this positioning state, the bending (elastic recovery force) of the side finisher 7 maintains the state in which the clips 9 of the fitting projections 70e and 70f are shallowly fitted into the fitting holes 63a and 65a (referred to as a temporary holding state). That is, even when the operator takes hands off the side finisher 7 in this temporary holding state, the side finisher 7 can be suppressed from falling off the mounting bracket 6. In addition, by the side finisher 7 being pushed toward the inside in the left-right direction from this temporary fixing state, the clips 9 (claw portions 91) of the fitting projections 70e and 70f can be easily fitted into the fitting holes 63a and 65a.

As described above, in the present embodiment, when the guide projection 70d slides along the guide groove 68, the displacement of the side finisher 7 in the up-down direction is restricted, and, when the guide projection 70d has slid to the terminal position of the guide groove 68, the displacement of the side finisher 7 in the left-right direction is also restricted. Accordingly, by the guide projection 70d being slid to the terminal position of the guide groove 68, the relative positions between the fitting holes 63a and 65a and the fitting projections 70e and 70f can be easily determined. That is, the need for the work of adjusting the relative positions between the fitting holes 63a and 65a and the fitting projections 70e and 70f can be substantially eliminated.

In addition, since the guide projection 70d is formed on the rear side of the fitting projections 70e and 70f, no portions that restrict the displacement of the side finisher 7 in the left-right direction are present in the region R2 in which the fitting projections 70e and 70f are formed or in a region on the front side of the region R2. As a result, in the region R2 in which the fitting projections 70e and 70f are formed, the side finisher 7 can be easily bent toward the outside in the left-right direction. Accordingly, the fitting projections 70e and 70f (clips 9) can be easily fitted into the fitting holes 63a and 65a, the workability of installation work of the side finisher 7 can be improved.

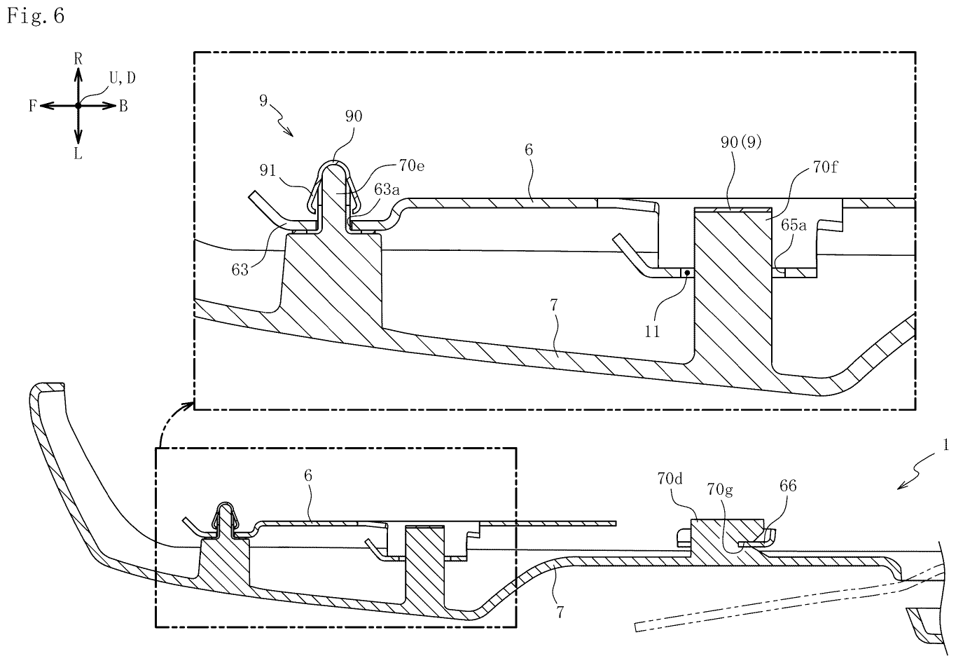

Next, a state in which the side finisher 7 has been attached to the mounting bracket 6 will be described with reference to FIG. 6. FIG. 6 is a partially enlarged cross-sectional view illustrating line IV-IV in FIG. 3 of the vehicle seat 1 in which the side finisher 7 has been attached to the mounting bracket 6.

As illustrated in FIG. 6, by the clips 9 of the fitting projections 70e and 70f being fitted into the fitting holes 63a and 65a with the hanging portion 66 inserted into the insertion groove 70g of the guide projection 70d, the side finisher 7 can be attached to the mounting bracket 6.

In this state in which the side finisher 7 has been attached, the claw portion 91 of the clip 9 mounted on the fitting projection 70e is engaged with the inside (arrow R side) in the left-right direction of the fitting portion 63 (fitting hole 63a). In the projecting direction (front-rear direction) (direction indicated by arrows F and B) of the claw portion 91 of the fitting projection 70e, the gap between the inner peripheral surface of the fitting hole 63a and the fitting projection 70e (the insertion portion 90 of the clip 9) is small, and accordingly, the displacement of the side finisher 7 in this direction is restricted by the engagement between the fitting projection 70e and the fitting hole 63a.

In addition, although not illustrated, also in the clip 9 of the fitting projection 70f, the gap between the inner peripheral surface of the fitting hole 65a and the fitting projection 70f (insertion portion 90 of the clip 9) in the projecting direction (up-down direction) (direction indicated by arrows U and D) of the claw portion 91 is small. Accordingly, the displacement of the side finisher 7 in the up-down direction is also restricted by the engagement between the fitting projection 70f and the fitting hole 65a.

As described above, the present embodiment includes the fitting projection 70e having the claw portion 91 projecting in the front-rear direction (first direction) and the fitting projection 70f having the claw portion 91 projecting in the up-down direction (second direction), which differ from the front-rear direction. As a result, the engagement between the fitting holes 63a and 65a and the fitting projections 70e and 70f (insertion portions 90 of the clips 9) effectively suppresses the play of the side finisher 7 in the front-rear direction and in the up-down direction.

On the other hand, in the front-rear direction (direction indicated by arrows F and B), which is orthogonal to the projecting direction (direction indicated by arrows U and D) of the claw portion 91 of the fitting projection 70f and the left-right direction (direction indicated by arrows L and R), a gap 11 is formed between the inner peripheral surface of the fitting hole 65a and the fitting projection 70f (insertion portion 90 of the clip 9). In addition, although not illustrated, also in the fitting projection 70e, a similar gap 11 extending in the up-down direction (direction indicated by arrows U and D), which is orthogonal to the projecting direction of the claw portion 91, is formed.

The gaps 11 between the fitting holes 63a and 65a and the fitting projections 70e and 70f are formed in the front-rear direction and in the up-down direction that differ from each other, and accordingly, the deposition error of the fitting projections 70e and 70f can be absorbed by the amount corresponding to the gaps 11. That is, even when error in the relative position of the fitting projections 70e and 70f occurs due to dimensional error of the side finisher 7 or the like, the fitting projections 70e and 70f (clips 9) can be fitted into the fitting holes 63a and 65a.

Here, when the occupant sits on the vehicle seat 1 or gets off the vehicle, the load from the occupant acts on the side finisher 7. This load will be described with reference to FIG. 1. A load directed diagonally backward left (the direction between arrow L and arrow B in FIG. 1) is likely to act on the front surface portion of the side finisher 7. In addition, a load directed diagonally downward left (the direction between arrow L and arrow D in FIG. 1) is likely to act on the upper surface portion of the side finisher 7.

On the other hand, since the fitting hole 63a (fitting projection 70e) is formed on the front end side of the side finisher 7 (on the front side of the center in the front-rear direction), a load directed diagonally backward left from the occupant is likely to act on the fitting portion between the fitting hole 63a and fitting projection 70e. On the other hand, since the fitting hole 65a (fitting projection 70f) is formed at the upper rear of the fitting hole 63a (fitting projection 70f), a load directed diagonally downward left from the occupant is likely to act on the fitting portion between fitting hole 65a and fitting projection 70f.

Accordingly, in the structure in which the gap 11 in the up-down direction is formed between the fitting hole 65a and the fitting projection 70f, when a load directed diagonally downward left (a load including a downward component) is applied to the fitting portion between the fitting hole 65a and the fitting projection 70f, the fitting projection 70f (clip 9) is more likely to be permitted to move out of the fitting hole 65a by the amount corresponding to the gap 11. Accordingly, a load from the occupant as described above makes the fitting projection 70f (clip 9) likely to be disengaged from the fitting hole 65a.

In addition, also in the structure in which the gap 11 in the front-rear direction is formed between the fitting hole 63a and the fitting projection 70e, a load from the occupant (a load directed diagonally backward left and including a backward component) makes the fitting projection 70e (clip 9) likely to be disengaged from the fitting hole 63a.

On the other hand, in the present embodiment, the gap 11 in the front-rear direction is formed between the fitting hole 65a and the fitting projection 70f (see the enlarged portion in FIG. 6). In addition, although not illustrated, the gap 11 in the up-down direction (U-D direction) is formed between the fitting hole 63a and the fitting projection 70e. As a result, even when the load from the occupant acts on the fitting portion between the fitting holes 63a and 65a and the fitting projections 70e and 70f (clips 9), the fitting projections 70e and 70f are less likely to be disconnected from the fitting holes 63a and 65a. Accordingly, the side finisher 7 can be stably fixed to the mounting bracket 6.

The present invention has been described based on the embodiment described above, but it is easy to infer that the present invention is not limited to the embodiment described above and various modifications and improvements can be made without departing from the spirit of the present invention.

A case in which the operating lever 5 is inclined to the outside in the left-right direction as approaching to the front end side has been described in the embodiment described above, but the operating lever 5 may also extend linearly along the front-rear direction.

A case in which the lateral guide surface 62a and the upper guide surface 64a that guide the sliding of the guide projection 70d are formed on the front side of the guide groove 68 has been described in the embodiment described above, but either or both of the lateral guide surface 62a and the upper guide surface 64a may be omitted.

A case in which the inclined surface 65c is formed on the front side of the fitting hole 65a or the inclined surface 70h is formed on the rear side of the insertion groove 70g has been described in the embodiment described above, but the inclined surfaces 65c and 70h may be omitted.

A case in which the low-stiffness region R1 having lower stiffness against bending in the left-right direction than the region R2 in which the fitting projections 70e and 70f are formed is formed has been described in the embodiment described above, but the present invention is not necessarily limited to this case. For example, the stiffness of the region R1 may be the same as the stiffness of the region R2, or the stiffness of the region R2 in which the fitting projections 70e and 70f are formed may be greater than the stiffness of the region R1.

In the embodiment described above, a case in which the displacement of the side finisher 7 in the left-right direction is restricted when the hanging portion 66 (rear end portion of the guide groove 68) is inserted into the insertion groove 70g has been described. That is, a case in which the displacement of the side finisher 7 in the left-right direction is not restricted in an initial stage of the sliding of the guide projection 70d in the guide groove 68 has been described, but the present invention is not necessarily limited to this case.

For example, the displacement of the side finisher 7 in the left-right direction may start to be restricted simultaneously with the start of insertion of the guide projection 70d into the guide groove 68. As an example of the structure described above, a wall that extends vertically from the guide projection 70d is formed, and this wall is engaged with the edges (inner surfaces of the upper guide portion 64 and the lower guide portion 67) of the inside in the left-right direction of the guide groove 68.

In addition, for example, a groove (a portion corresponding to the insertion groove 70g) is formed on the side closer to the mounting bracket 6, an insertion piece (a portion corresponding to the hanging portion 66) is formed on the side closer to the side finisher 7, and the displacement of the side finisher 7 in the left-right direction may be restricted by the engagement between the groove and the insertion piece.

A case in which the clips 9 including the insertion portions 90 and the claw portions 91 are mounted on the fitting projections 70e and 70f has been described in the embodiment described above, but the present invention is not necessarily limited to this case. For example, the structure in which claws (projections corresponding to the claw portions 91) formed integrally with the fitting projections 70e and 70f are engaged with the fitting holes 63a and 65a may be adopted, and, in this structure, the fitting projections 70e and 70f correspond to the insertion portions to be inserted into the fitting holes 63a and 65a.

A case in which the fitting projection 70e including the claw portion 91 projecting in the front-rear direction (first direction) and the fitting projection 70f including the claw portion 91 projecting in the up-down direction (second direction) are provided has been described in the embodiment described above, but the present invention is not necessarily limited to this case. For example, one of the fitting projections 70e and 70f may be omitted, or another fitting projection (fitting hole) may be provided in addition to the fitting projections 70e and 70f. In addition, the claw portions 91 of the fitting projections 70e and 70f may project in a direction inclined with respect to the front-rear direction or the up-down direction, or the projecting direction of the claw portion 91 may be the same between the fitting projection 70e and the fitting projection 70f.

A case in which the gaps 11 between the fitting holes 63a and 65a and the fitting projections 70e and 70f are formed in the front-rear direction and the up-down direction that differ from each other has been described in the embodiment described above, but a structure that does not include the gaps 11 as described above may be adopted.

### DESCRIPTION OF REFERENCE NUMERALS

1 vehicle seat
2 cushion frame
20 side frame
5 operating lever
6 mounting bracket
62a lateral guide surface
63a fitting hole (first fitting hole)
65a fitting hole (second fitting hole)
65b outer surface of fitting portion (first surface)
65c inclined surface (second surface)
66 hanging portion (rear end portion of guide groove)
68 guide groove
7 side finisher
70c insertion hole
70d guide projection
70e fitting projection (first fitting projection)
70f fitting projection (second fitting projection)
70g insertion groove
70h inclined surface
90 insertion portion
91 claw portion
11 gap
R1 low-stiffness region
R2 region in which fitting projection is formed

What is claimed is:

1. A vehicle seat comprising:
a side frame, provided in a cushion frame, that extends in a front-rear direction;
an operating lever, provided on a lateral side of the side frame, that is operated by an occupant; and
a side finisher that has an insertion hole into which the operating lever is inserted and that covers a side surface of the side frame,
wherein the side finisher includes a guide projection and a fitting projection, formed on a front side of the insertion hole, that project to a side closer to the side frame,
the side closer to the side frame has a guide groove that extends in the front-rear direction and into which the guide projection is slidably inserted through an opening portion on a front end side, and a fitting hole into which the fitting projection is fitted from the lateral side,
the guide projection restricts displacement of the side finisher in an up-down direction and in a left-right direction at least at a terminal position of sliding toward a rear end side of the guide groove, and
the guide projection is formed on a rear side of the fitting projection.

2. The vehicle seat according to claim 1,
wherein the operating lever is inclined to an outside in the left-right direction as approaching to a front end side.

3. The vehicle seat according to claim 1,
wherein the side closer to the side frame has a guide surface, extending in the front-rear direction, that faces the side finisher on a front side of the guide groove, and
displacement of the guide projection toward an inside in the left-right direction is restricted by the guide surface when the guide projection slides toward the rear end side of the guide groove.

4. The vehicle seat according to claim 1,
wherein the side closer to the side frame has a first surface in which the fitting hole is formed and a second surface, continuous with a front edge of the first surface, that is inclined to an inside in the left-right direction as moving away from the first surface to the front side, and
the fitting projection is slidable along the second surface when the guide projection slides toward the rear end side of the guide groove.

5. The vehicle seat according to claim 1,
wherein an insertion groove that vertically passes through the guide projection and into which a rear end portion of the guide groove is inserted is formed in a rear surface of the guide projection, and
an inclined surface inclined to expand a groove width in the left-right direction of the insertion groove toward the rear side is formed at a rear end of the insertion groove.

6. The vehicle seat according to claim 1,
wherein the side finisher has a low-stiffness region in which stiffness against bending in the left-right direction is lower than stiffness in a region in which the fitting projection is formed, and
the low-stiffness region is formed between the guide projection and the fitting projection.

7. The vehicle seat according to claim 1, further comprising:
a mounting bracket in which the guide groove and the fitting hole are formed, the mounting bracket being attached to a side surface of the side frame.

8. The vehicle seat according to claim 1,
wherein the fitting projection includes an insertion portion inserted into the fitting hole and a claw portion that projects in a direction orthogonal to the left-right direction from the insertion portion and is engaged with the inside in the left-right direction of the fitting hole,
the displacement of the side finisher is restricted by engagement between the fitting hole and the insertion portion in the direction in which the claw portion projects, and a gap is formed between the fitting hole and the insertion portion in a direction orthogonal to the left-right direction and the direction in which the claw portion projects,
the fitting hole includes at least a first fitting hole and a second fitting hole, and
the fitting projection includes at least a first fitting projection, fitted into the first fitting hole, that includes the claw portion projecting in a first direction and a second fitting projection, fitted into the second fitting hole, that includes the claw portion projecting in a second direction that differs from the first direction.

9. The vehicle seat according to claim 8,
wherein the first fitting projection is formed on a front end side of the side finisher,
the second fitting projection is formed at an upper rear of the first fitting projection,
the gap in the up-down direction is formed between the first fitting hole and the first fitting projection, and
the gap in the front-rear direction is formed between the second fitting hole and the second fitting projection.
